(19) United States
(12) Patent Application Publication
(10) Pub. No.: US 2018/0248784 A1
(43) Pub. Date: Aug. 30, 2018

(54) COMMUNICATION APPARATUS, COMMUNICATION METHOD, AND STORAGE MEDIUM

(71) Applicant: CANON KABUSHIKI KAISHA, Tokyo (JP)

(72) Inventor: Masanori Fukada, Tokyo (JP)

(21) Appl. No.: 15/889,336

(22) Filed: Feb. 6, 2018

(30) Foreign Application Priority Data
Feb. 24, 2017 (JP) 2017-033725
Jan. 17, 2018 (JP) 2018-005948

(51) Int. Cl. H04L 12/707; H04L 12/24

(52) U.S. Cl. CPC H04L 45/22; H04L 41/0654; H04L 45/24

(57) ABSTRACT

There is provided with a communication apparatus which performs, for example, dynamic sub flow priority control in a multipath TCP connection. The communication apparatus has a transceiver configured to communicate with another communication apparatus by establishing a TCP (Transmission Control Protocol) connection that includes a plurality of transport layer connections with different priorities and through different paths. The communication apparatus also has a controller configured to change the priorities of the plurality of transport layer connections based on at least one of setting information of the communication apparatus or usage history information relating to the paths, after the TCP connection with the other communication apparatus is established by the transceiver.

### BACKGROUND OF THE INVENTION

### Field of the Invention

The present invention relates to a communication apparatus, a communication method, and a storage medium, and in particular relates to dynamic sub flow priority control in a multipath connection.

### Description of the Related Art

In recent years, accompanying the diversification of interfaces used in network communication, devices mounted with a plurality of network interfaces are increasing. However, in TCP which is conventionally used, because it is not possible for IP addresses assigned to different interfaces in the same connection to be used differently, as a result, communication with a communication destination can only be performed on one path that uses one interface. Accordingly, even if a TCP connection is first established, if a state where communication via one path cannot be performed is entered, the TCP connection is disconnected. Because it takes time to establish the connection again, this leads to a deterioration in a user experience.

A protocol referred to as multipath TCP (MPTCP) has been proposed in order to solve such a problem (Japanese Patent Laid-Open No. 2014-530564). MPTCP is an extension of conventional TCP, and is a technique for realizing a TCP connection with a communication partner by using a plurality of paths at the same time. A dataflow via respective paths is referred to as sub flows. In MPTCP, it is possible to define the role of a path. For example, by setting a plurality of paths as regular paths, it is possible to use a plurality of sub flows to enlarge bandwidth. In addition, it is also possible to use a plurality of paths redundantly. For example, by setting some paths to be regular paths and setting remaining paths as backup paths, in a case where communication quality of the regular path has decreased, it is possible to use the backup paths to recover the communication quality. The roles of these paths can be decided in accordance with a value of a bit that indicates a priority inside the header of a packet that is sent/received at a time of establishing sub flows. In addition, it is possible to change the role of a path by storing information for requesting a priority change in the header of a packet send to a sub flow in a case where usable paths changed. A layer for controlling data transmission/reception in an MPTCP connection decides, in accordance with a priority of each sub flow, which sub flow to use in sending data.

### SUMMARY OF THE INVENTION

According to an embodiment of the present invention, a communication apparatus comprises: a transceiver configured to communicate with another communication apparatus by establishing a TCP (Transmission Control Protocol) connection that includes a plurality of transport layer connections with different priorities and through different paths; and a controller configured to change the priorities of the plurality of transport layer connections based on at least one of setting information of the communication apparatus or usage history information relating to the paths, after the TCP connection with the other communication apparatus is established by the transceiver.

According to another embodiment of the present invention, a communication method comprises: establishing a TCP (Transmission Control Protocol) connection from a communication apparatus to another communication apparatus, wherein the TCP connection includes a plurality of transport layer connections with different priorities and through different paths; and changing the priorities of the plurality of transport layer connections based on at least one of setting information of the communication apparatus or usage history information relating to the paths, after establishing the TCP connection.

According to still another embodiment of the present invention, a non-transitory computer-readable medium stores a program which, when executed by a processor of a communication apparatus, causes the communication apparatus to: establish a TCP (Transmission Control Protocol) connection from the communication apparatus to another communication apparatus, wherein the TCP connection includes a plurality of transport layer connections with different priorities and through different paths; and change the priorities of the plurality of transport layer connections based on at least one of setting information of the communication apparatus or usage history information relating to the paths, after establishing the TCP connection.

Further features of the present invention will become apparent from the following description of exemplary embodiments (with reference to the attached drawings).

### BRIEF DESCRIPTION OF THE DRAWINGS

FIG. 1 is a view which illustrates an example of a hardware configuration of a communication processing apparatus according to an embodiment.

FIG. 2 is a view which illustrates an example of a software configuration of a communication processing apparatus according to an embodiment.

FIG. 3 is a flowchart which describes a communication control method according to an embodiment.

FIG. 4 is a view which illustrates a network configuration which is used in an embodiment.

FIG. 5 is a state transition diagram of a communication processing apparatus in an embodiment.

FIG. 6 is a flowchart for describing a communication control method according to an embodiment.

FIG. 7 is a flowchart for describing priority deciding processing in an embodiment.

FIG. 8 is a flowchart for describing priority deciding processing in an embodiment.

FIG. 9 is a view which illustrates a network configuration which is used in an embodiment.

FIG. 10 is a flowchart for describing priority deciding processing according to an embodiment.

### DESCRIPTION OF THE EMBODIMENTS

Thus far changing the role of a path in multipath TCP has been merely performed if a usable path changed. Accordingly, dynamically changing the role of a path in accordance with, for example, a setting or a state of a device and independently of a communication channel status has not been performed.

An embodiment of the present invention enables causing a communication device to efficiently operate by flexibly changing the role of a path.

Hereinafter, embodiments of the present invention are described based on the drawings. However, the scope of the present invention is not limited to the following embodiments.

### First Embodiment

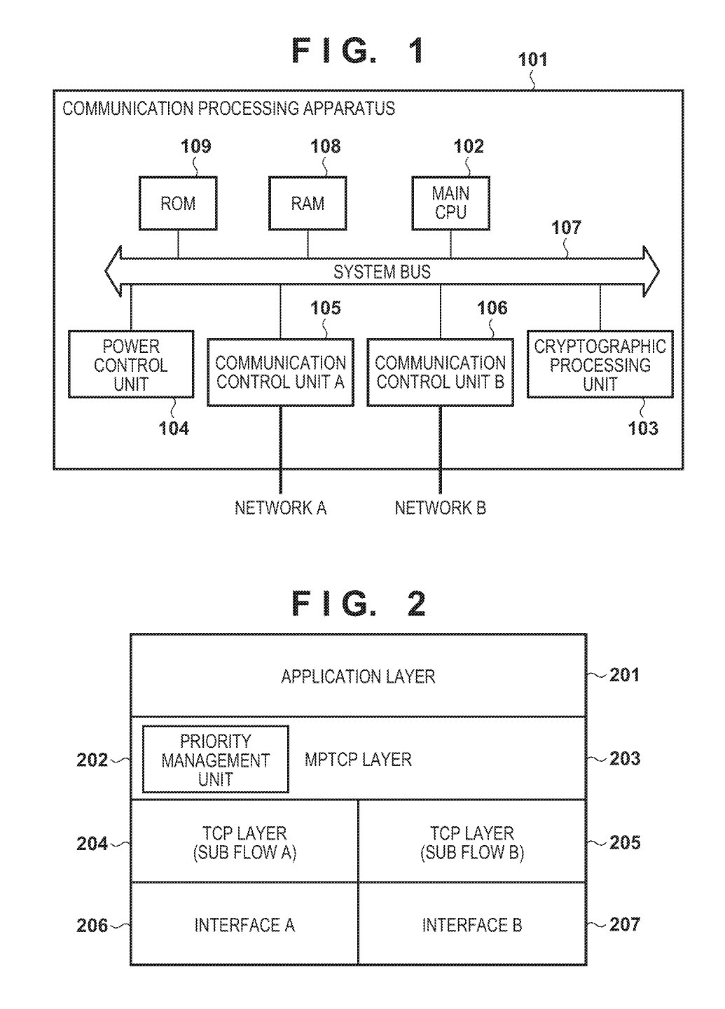

FIG. 1 is used to give an explanation regarding an example of a hardware configuration of a communication processing apparatus 101 according to a first embodiment. The communication processing apparatus 101 has a main CPU 102, a cryptographic processing unit 103, a power control unit 104, a communication control unit A 105, a communication control unit B 106, a system bus 107, a RAM 108, and a ROM 109.

The main CPU 102, the ROM 109 which stores a system program, and the RAM 108 which is a temporary storage apparatus used at a time of execution of application software or system software are connected to the system bus 107. The power control unit 104 which controls power for the entirety of the communication processing apparatus 101, the communication control unit A 105 and the communication control unit B 106 which connect with a network and send/receive frames, and the cryptographic processing unit 103 which encrypts and decrypts data are also connected to the system bus 107.

Processing according to the present embodiment can be realized by a software program that includes commands for executing the processing being read from the ROM 109 to the RAM 108, and executed by the main CPU 102. The main CPU 102 performs system control of the entirety of the communication processing apparatus 101, and performs protocol processing for communicating with a communication destination or application software processing of the communication processing apparatus 101.

The power control unit 104 receives a change instruction for an operation state of the communication processing apparatus 101. The power control unit 104 changes the operation state of the communication processing apparatus 101 in accordance with the change instruction. For example, the power control unit 104 can receive a transition instruction for a power mode of the communication processing apparatus 101, and can control a power mode transition for the communication processing apparatus 101. In the present embodiment, the communication processing apparatus 101 can operate in any of a plurality of power modes that have different power consumption, in accordance with control by the power control unit 104. For example, the communication processing apparatus 101 can change an operation state between a normal power state and a power saving state.

Specifically, the power control unit 104 can receive an operation state change instruction that is inputted by a user who uses a button or the like. In addition, the power control unit 104 can also receive an operation state change instruction from each unit that the communication processing apparatus 101 has, a communication destination of the communication processing apparatus 101, an external apparatus different to the communication processing apparatus 101, a relay apparatus for communication, or the like. In addition, the power control unit 104 can receive an operation state change instruction that the main CPU 102 generates in accordance with the communication processing apparatus 101 being in an idle state for a predetermined amount of time or more. Note that, as described later, an operation state change instruction includes an instruction for changing the operation state in sending data to a communication destination so that the role of a path is changed, and this change instruction can also be obtained by a control unit other than the power control unit 104.

Another example of an operation state change instruction includes an instruction for changing an application execution mode of the communication processing apparatus 101. Specifically, the communication processing apparatus 101 may have a normal mode and a mode for executing an application at high speed. In the latter mode, it is possible to change the role of a path so as to preferentially use a path that does not need a securing process by the main CPU 102, for example, in order to reduce a load on the main CPU 102.

The power control unit 104 can control a power supply of the entirety of the communication processing apparatus 101. For example, in a case of waiting with a main function of the communication processing apparatus 101 turned off, the power control unit 104 can reduce an operation clock of each unit, and disconnect a power supply for a hardware circuit that can stop operation temporarily. In addition, the power control unit 104 can perform sequence control for activating or stopping the entirety of the communication processing apparatus 101, as well as hardware reset control and power activation control for each unit.

The cryptographic processing unit 103 performs a securing process in communication. For example, the cryptographic processing unit 103 can, in accordance with control by the main CPU 102, encrypt and decrypt data communicated with another communication apparatus by using a cryptographic key managed in the RAM 108. In addition, in a case where cryptographic communication cannot be performed, it is possible to stop the power supply of the cryptographic processing unit 103 or reduce an operating frequency of the cryptographic processing unit 103, in accordance with control by the power control unit 104.

The communication processing apparatus 101 connects to a network A 111 via the communication control unit A 105, and connects to a network B 112 via the communication control unit B 106. Types of the network A 111 and the network B 112 are not limited. For example, they may be a wired network such as an Ethernet (registered trademark) or optical fiber network, or a wireless network such as 3G, LTE, Bluetooth (registered trademark), or a wireless LAN defined by IEEE 802.11. In one embodiment, the network A 111 and the network B 112 are networks of differing methods. For example, configuration may be taken such that one of the network A 111 and the network B 112 is a wired network and the other is a wireless network, or one is a wireless network in accordance with a first specification and the other is a wireless network in accordance with a second specification. In the present embodiment, it is assumed that a remote controller for operating the communication processing apparatus 101 can perform communication that uses an MPTCP protocol via the network A 111 or the network B 112. Here MPTCP is an abbreviation of Multi Path TCP (Transmission Control Protocol).

The communication control unit A 105 sends/receives transmission frames with respect to the network A 111, and the communication control unit B 106 sends/receives transmission frames with respect to the network B 112. For example, in a case where the network A 111 is Ethernet (registered trademark), the communication control unit A 105 performs processing for sending and receiving transmission frames, and MAC processing for Ethernet (registered trademark) (transmission media control processing).

The main CPU 102 performs MPTCP processing in addition to communication processing of a general-purpose TCP/IP protocol. More specifically, the main CPU 102 performs communication error control, congestion control, send flow control, and communication protocol processing such as for IPv4, IPv6, IPsec, ICMP, UDP, or TCP. In addition, the main CPU 102 performs MPTCP sub flow path management, congestion control for a plurality of sub flows, packet scheduling, and processing for an MPTCP protocol. Such a protocol processing function of the main CPU 102 may be executed by a separate functional block. In addition, this processing may be performed by using a multiprocessor configuration in accordance with a plurality of microprocessors. Furthermore, configuration may be taken to perform acceleration by executing some functions by separate hardware, in addition to processing by a microprocessor. It is possible to independently control a power supply with respect to each microprocessor or piece of hardware.

The communication processing apparatus 101 as above can be used in combination with various devices. For example, the communication processing apparatus 101 may be an image display apparatus such as a projector, and the communication processing apparatus 101 may be connected to an image generation apparatus such as a PC. In addition, as described above, a type of network that the communication processing apparatus 101 can use is not particularly limited. For example, the communication processing apparatus 101 can simultaneously use both of a connection with a communication destination via public wireless, and a connection with the communication destination via a LAN. By such a configuration, the communication processing apparatus 101 is capable of continuing communication even if the communication destination is far away. In addition, the communication processing apparatus 101 can simultaneously use both of a connection with a communication destination that passes through intracompany infrastructure, and a connection with the communication destination that does not pass through the intracompany infrastructure (for example, FIG. 4). Consideration may be given for a configuration for increasing the security of the intracompany infrastructure by providing a communication path that does not pass through the intracompany infrastructure, so that an outside merchant can connect to the communication processing apparatus 101 without passing through the intracompany infrastructure such as at a time of maintenance. With such a configuration, by using two connections simultaneously, continuous communication becomes possible.

FIG. 2 illustrates a software hierarchical view in communication processing wherein the main CPU 102 performs processing. In an application layer 201, application control and processing of data sent and received by an application with respect to a communication destination is executed. In addition, in the application layer 201, a packet send/receive request is performed with respect to an MPTCP layer 203. In the present embodiment, communication that uses MPTCP is performed between the communication processing apparatus 101 and the communication destination. Note that in a case of not performing communication that uses MPTCP with a communication destination, the application layer 201 performs communication with the communication destination via a TCP layer and without going through the MPTCP layer 203. In addition, in a case where MPTCP communication with a communication destination is tried but the communication destination does not support MPTCP, communication with the communication destination is performed by using a normal TCP connection. Note that MPTCP is an extension of a layer that is lower than the application layer 201. Accordingly, a boundary between the application layer 201 and the MPTCP layer in FIG. 2 is the same as the boundary between the application layer 201 and a conventional TCP layer. Accordingly, there is no need to manage and control a plurality of paths within the application layer 201, and the application layer 201 can perform communication that uses a plurality of paths by performing control similar to communication that uses a conventional TCP connection.

By changing a setting of a priority management unit 202, the application layer 201 can control whether or not to perform priority control of an MPTCP sub flow in a case where a predetermined condition which is described later occurs. The application layer 201 can notify the priority management unit 202 of whether to use MPTCP for a bandwidth enlargement purpose or for redundant connections with a plurality of communication channels. In addition, configuration may be taken to decide whether to use MPTCP for a bandwidth enlargement purpose or for redundant connections in accordance with a determination by the MPTCP layer 203, instead of the application layer 201 performing control.

The MPTCP layer 203 sends and receives data by using a plurality of IP addresses and port numbers. In other words, the MPTCP layer 203 performs communication with the communication destination by using a plurality of sub flows. In the present embodiment, communication with the communication destination is performed by using a sub flow A 204 and a sub flow B 205 of the TCP layer, in other words by using a plurality of paths. In this way, communication between the application layer 201 and the communication destination based on a single connection is performed using a plurality of paths. The sub flow A 204 and the sub flow B 205 are managed by the MPTCP layer 203.

With such a configuration, the communication control unit A 105 and the communication control unit B 106 perform communication with the communication destination after establishing a plurality of transport layer connections via paths that are different from each other. Regarding a connection established with a communication destination in the present embodiment, one TCP (Transmission Control Protocol) connection is a TCP connection that includes a plurality of transport layer connections that pass through different paths. A path connected with the communication destination by the sub flow A 204 is connected to a network (for example the network A 111) via an interface A 206. A path connected with the communication destination by the sub flow B 205 is connected to a network (for example the network B 112) via an interface B 207. FIG. 2 illustrates the sub flow A 204 and the sub flow B 205 as sub flows managed by the MPTCP layer 203, but any number of sub flows greater than or equal to 2 can be used in an MPTCP connection in the present embodiment. Here, as described later, each path has a priority (or a role), and each can have a priority (role) as a regular path, or a priority (role) as a backup path, for example.

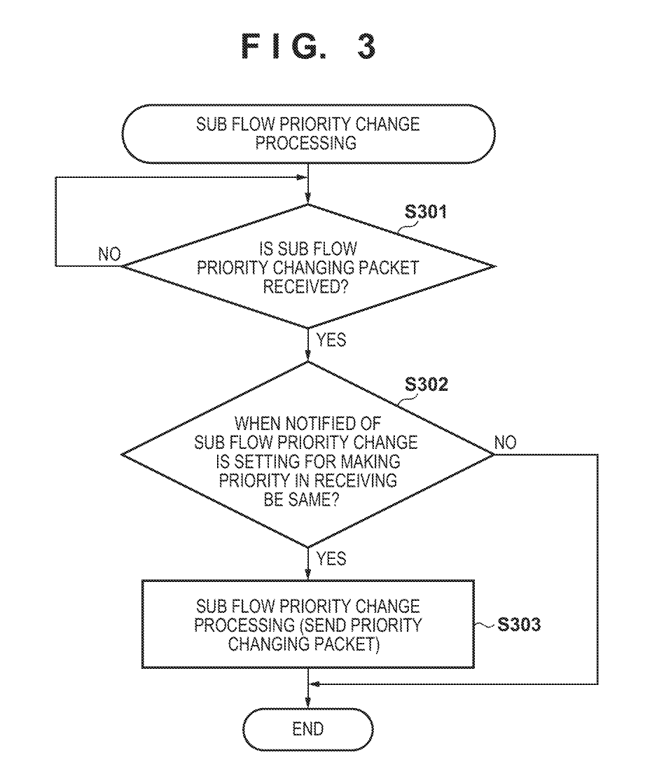

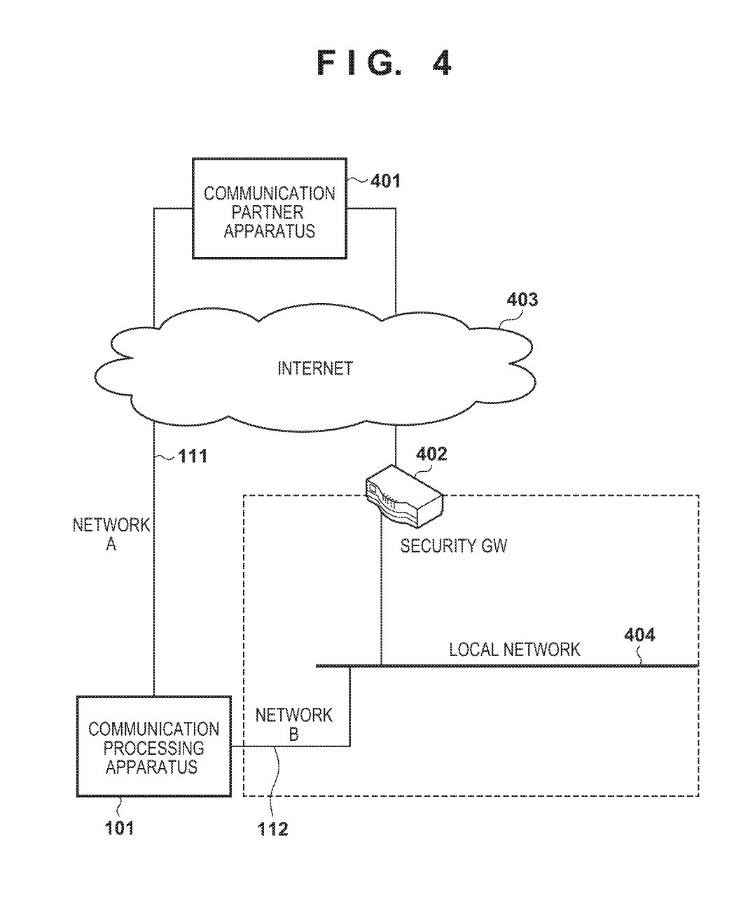

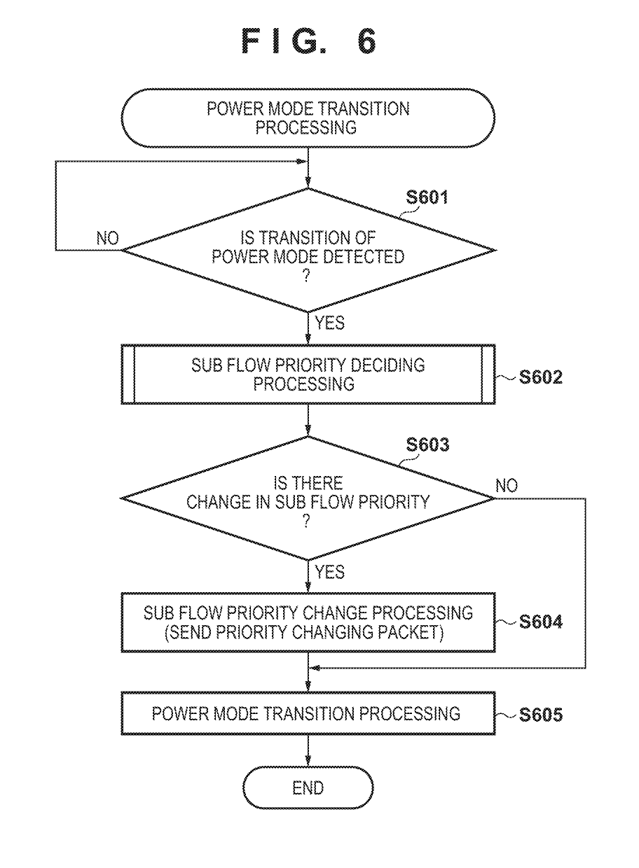

The MPTCP layer 203 has the priority management unit 202. The priority management unit 202 refers to setting information that is defined in advance to determine how to change a role of a path in accordance with a change instruction obtained by the power control unit 104, the communication control unit A 105, or the communication control unit B 106. The setting information is information set in the communication processing apparatus 101 in order to control an operation for changing the role of a path. For example, the setting information is information used when determining how to change the role of a path in accordance with a change instruction, or is information for defining how to change the role of a path in accordance with a change instruction. The priority management unit 202 performs control for changing the role of a path in accordance with the determination. This processing is explained in detail later with reference to FIG. 3 and FIG. 6.

By making an MPTCP connection, the application layer 201 can enlarge communication bandwidth by using a plurality of paths. Here, the role of each path can be selected from a regular path and a backup path used when there is a problem in communication through a regular path. For example, it is possible to enlarge the communication bandwidth by, in accordance with control by the priority management unit 202, performing communication using both of the sub flow A 204 and the sub flow B 205 which are set to regular paths. In addition, by making an MPTCP connection, the application layer 201 is capable of a redundant connection that uses a regular path and a backup path. In this case, when the communication path of the regular path is disconnected, it is possible to recover the communication connection at high speed by using the backup path. For example, in accordance with control by the priority management unit 202, it is possible to perform communication that uses the sub flow B 205 in a case where the sub flow A 204 is normally used to perform communication but the communication through the sub flow A 204 became impossible. In addition, in a case where a problem has occurred in communication because bandwidth has become insufficient in communication that goes through the regular path, the bandwidth may be enlarged by performing communication that uses the backup path. In the present embodiment, the role of a path is selected from a regular path through which a prioritized sub flow passes and a backup path through which a backup sub flow passes, and therefore information indicating the role of a path may be referred to below as the priority of a sub flow.

Next, with reference to FIG. 3, explanation is given regarding a flow of processing in the priority management unit 202 for changing the priority of a sub flow. In the present embodiment, the communication control unit A 105 or the communication control unit B 106 receive from a communication destination a request to change the role of a path for a time of sending data to the communication destination (step S301). This request can be said to be an instruction for changing an operation state in sending data to the communication destination so that the role of the path is changed. In accordance with reception of this request, control for changing the role of the path in receiving data from the communication destination is performed (step S303). As a concrete example, it is possible to change the role of a path in receiving data from a communication destination so that it becomes the same as the role of the path in sending data to the communication destination. Here, by sending to the communication destination a request for changing the role of a path in receiving data from the communication destination, it is possible to change the role of a path in receiving data from the communication destination.

Step S301 is repeated until the MPTCP layer 203 receives a priority changing packet indicating that the priority of a sub flow from the communication destination is to be changed. When the MPTCP layer 203 receives a priority changing packet, the processing proceeds to step S302. Note that, in the present embodiment, a priority changing packet indicates a packet to which an MP_PRIO option, which is one MPTCP option, has been added. In accordance with the MPTCP protocol, a priority change that uses the MP_PRIO option is defined so that it can only be requested by a data receiving side, and it is defined so that a data sending side conforms to this request. In other words, the priority changing packet can be said to be a notification for changing the priority of the sub flow when the communication processing apparatus 101 is on a sending side and sends data to the communication destination.

In step S302, the priority management unit 202 refers to the setting information, and determines how to change the role of the path in accordance with the change instruction. The setting information in the present embodiment is information that indicates whether to change the role of a path in accordance with a change instruction. In other words, the priority management unit 202 refers to this setting information and determines whether to change the role of the path in accordance with the change instruction. For example, the setting information can indicate whether a setting is valid to make, upon receiving a notification for changing the priority of a sub flow where the communication processing apparatus 101 is a sending side, the priority of a sub flow where the communication processing apparatus 101 is the receiving side be the same. The priority management unit 202 can confirm the setting. If the setting is invalid, the processing of FIG. 3 ends. In this case, the priority management unit 202 can change the priority of the sub flow where the communication processing apparatus 101 is the sending side, in accordance with the notification. Meanwhile, if this setting is valid, the processing proceeds to step S303.

In step S303, the priority management unit 202 sends to the communication destination a notification for changing the priority of the sub flow where the communication processing apparatus 101 is the receiving side and receives data from the communication destination. For example, the priority management unit 202 can send a packet for which the MP_PRIO option is added to the communication destination via the sub flow. In this manner, the priority management unit 202 can control the priority of a sub flow. For example, in a case of receiving a notification for changing the role of a path, where the communication processing apparatus 101 is a sending side, to a backup path, it is possible to send a notification for changing the role of the path, where the communication processing apparatus 101 is a receiving side, to a backup path.

As described above, in accordance with a predetermined condition, for example that a setting is valid to make the priority of the sub flow where the communication processing apparatus 101 is a sending side be the same, the communication processing apparatus 101 can control the priority of a sub flow used by the communication processing apparatus 101. Specifically, the priority management unit 202 can, in accordance with whether the predetermined condition is satisfied, control the priority of a sub flow that the communication processing apparatus 101 uses for reception of data. It goes without saying that a type of the predetermined condition is not particularly limited. For example, configuration may be taken such that the priority management unit 202 performs control for changing the role of a path in receiving data from a communication destination, based on a simple condition, that is, to receive from the communication destination a request for changing the role of the path in sending data to the communication destination.

By using such a configuration, the communication destination can control the priority of a sub flow used by the communication processing apparatus 101. Specifically, the communication destination can control the priority of the sub flow that the communication processing apparatus 101 uses for reception of data in addition to controlling the priority of a sub flow that the communication destination uses for reception of data, through sending of a priority changing packet. In further embodiments, the priority management unit can, based on both of control from the communication destination and a condition such as a setting of the communication processing apparatus 101, control the priority of a sub flow used by the communication processing apparatus 101.

In the present embodiment, explanation is given regarding processing for changing the priority of a sub flow when a priority changing packet is received from a communication destination. However, how to change a priority is not particularly limited to this. Even if another method is used, it is possible to dynamically change a sub flow priority based on control from a communication destination or a setting of the communication processing apparatus 101, for example, independently of a communication channel status.

By virtue of the present embodiment, it is possible to dynamically change the priority of a sub flow independently of a communication channel status, in the communication processing apparatus 101. By virtue of the present embodiment, efficient communication processing is possible because it is possible to dynamically change the priority of a sub flow based on a condition such as control from a communication destination or terminal conditions such as a setting of a communication processing apparatus. In addition, in the present embodiment in which the priority of a path is switched in this way, it is possible to quickly perform communication with a newly prioritized path after the switch, in comparison to a configuration in which a path is switched by reestablishing a TCP session.

The communication processing apparatus 101 indicated in the present embodiment is capable of more efficient operation by operating as a communication destination of a communication processing apparatus according to second or third embodiments which are described later, for example. In other words, when the communication processing apparatus according to the present embodiment is a communication destination, the communication processing apparatus according to the second or third embodiments can control the priority of a sub flow in downlink communication in addition to the priority of a sub flow in an uplink communication, by sending a priority changing packet.

In addition, it is possible for a communication destination to make a notification to the communication processing apparatus 101 to cause it to change the priority of a sub flow, when the communication destination detects a reduction in communication quality of a regular path. In this case, by the MPTCP protocol, the communication processing apparatus, upon receiving the notification from the communication destination, merely changes the priority of the sub flow used in sending data. Accordingly, when the communication processing apparatus independently detects a reduction in communication quality of a regular path, it sends a notification to the communication destination to cause the priority of a sub flow used in sending to be changed, and thereby it changes the priority of the sub flow used when the communication processing apparatus receives data. In this way, in order for the communication processing apparatus 101 to change the priority of a sub flow used in data reception, there is a need for the communication processing apparatus 101 to separately detect a deterioration in communication quality of the sub flow and make a notification to the communication destination for changing the priority, and this is not efficient. By the method of the present embodiment, more efficient operation is possible because a change of the priority of a sub flow in communication in one direction performed when the communication destination detects a reduction of communication quality can be quickly applied to communication in the reverse direction.

### Second Embodiment

In the first embodiment, in accordance with receiving a request to change the priority of a sub flow in communication directed to a communication destination, the priority of a sub flow in communication of the opposite direction is decided in accordance with the setting of a communication processing apparatus. In the second embodiment, the priority of a sub flow in communication in accordance with a security setting is decided in accordance with a change of state of the communication processing apparatus. The configuration of the communication processing apparatus 101 according to the present embodiment is similar to the configuration according to the first embodiment illustrated in FIG. 1 and FIG. 2. Below, explanation is given regarding a configuration different to that of the first embodiment, and explanation for a configuration similar to that of the first embodiment is omitted.

An example of a configuration of a network to which the communication processing apparatus 101 according to the second embodiment is connected is explained by using FIG. 4. In FIG. 4, illustration is given for an example in which a sub flow via the network A 111 and a sub flow via the network B 112 are used in a connection between the communication processing apparatus 101 and a communication partner apparatus 401. Of course the number of sub flows used is not limited, and any number of sub flows that is greater than or equal to two can be used.

The network A 111 to which the communication processing apparatus 101 is connected is directly connected to the communication partner apparatus 401 via the Internet 403. In addition, the network B 112, to which the communication processing apparatus 101 is connected, is connected to a local network 404 such as an intracompany network. Packets sent and received between the communication processing apparatus 101 and the communication partner apparatus 401 via a network B pass through a security gateway (GW) 402 that connects the local network 404 and the Internet 403.

The communication partner apparatus 401 performs communication for which security is guaranteed by using an IPsec protocol. For example, for a sub flow between the communication processing apparatus 101 and the communication partner apparatus 401 via the network A 111, a security connection is maintained between the communication processing apparatus 101 and the communication partner apparatus 401 in accordance with a transport mode or a tunnel mode. In contrast, for a sub flow between the communication processing apparatus 101 and the communication partner apparatus 401 via the network B 112, a security connection is maintained between the security GW 402 and the communication partner apparatus 401 in accordance with a tunnel mode. A packet subject to IPsec processing by the security GW 402 is sent and received as a plaintext packet within the local network 404, in other words between the security GW 402 and the communication processing apparatus 101.

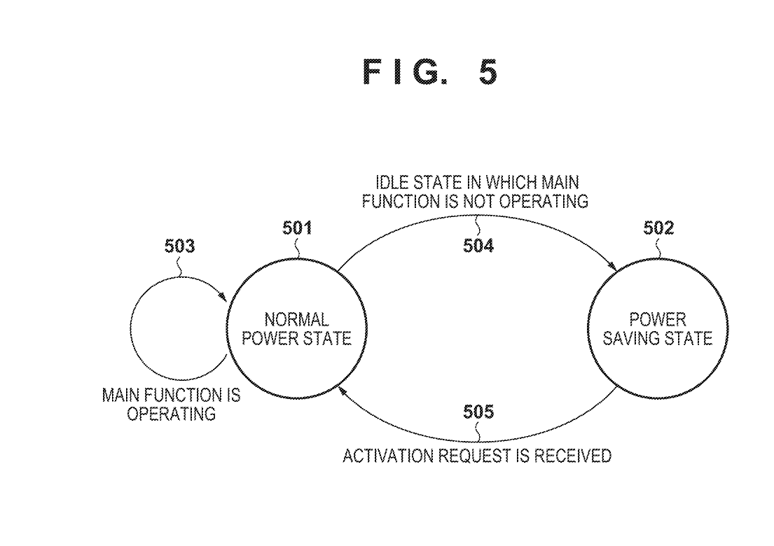

The communication processing apparatus 101 can enter the normal power state or the power saving state. FIG. 5 is a state transition diagram for the communication processing apparatus 101. While a main function of the communication processing apparatus 101 is operating, the communication processing apparatus 101 maintains a normal power state 501 (reference numeral 503). In the normal power state 501, power is supplied to the entirety of the communication processing apparatus 101. Meanwhile, when an idle state where the main function is not executed is entered in the normal power state 501, the communication processing apparatus 101 can transition to a power saving state 502 in accordance with control by the main CPU 102, for example. In addition, the communication processing apparatus 101 can transition from the power saving state 502 to the normal power state 501 when the communication processing apparatus 101 receives a system activation request from the network, for example (reference numeral 505).

In addition, the power control unit 104 may be connected with an external switch that can be operated by a user. In this case, in accordance with a press of the switch, the communication processing apparatus 101 can transition from the normal power state 501 to the power saving state 502, and can transition from the power saving state 502 to the normal power state 501.

In the power saving state 502, a reduction of operating frequency in the entirety of the communication processing apparatus 101 is performed in accordance with control by the power control unit 104. In addition, when the communication processing apparatus 101 has dedicated hardware circuits for realizing each functional block, in the power saving state 502 it is possible to supply power to minimum hardware circuits necessary for a power saving wait. In a case where the communication processing apparatus 101 has a multiprocessor configuration in accordance with a plurality of microprocessors or in a case where the communication processing apparatus 101 has a configuration for performing acceleration by hardware, it is similarly possible to supply power to minimal hardware. In this way, in the power saving state 502 it is possible to reduce an electric power consumption amount of the communication processing apparatus 101 more than when in the normal power state 501. The power saving state 502 may be provided with a plurality of modes that are selected in accordance with a network usage status, a user setting, or the like. In this case, the power control unit 104 can perform power supply control so that an electric power consumption amount of the communication processing apparatus 101 is different in each mode.

In the present embodiment, in the normal power state 501, and in the MPTCP connection between the communication processing apparatus 101 and the communication partner apparatus 401, a sub flow via the network A 111 is used as a regular path. In addition, a sub flow via the network B 112 is used as a backup path. As described above, security is guaranteed by the communication processing apparatus 101 for the sub flow via the network A 111. Meanwhile, security is guaranteed by the security GW 402 for the sub flow via the network B 112, in other words via the local network 404. In this way, by using the sub flow via the network A 111 as a regular path, it is possible to reduce the load applied to the local network 404.

Meanwhile, when the communication processing apparatus 101 transitions to the power saving state 502, the sub flow priority is changed by using a method that is described later. Consequently, switching of the priority is performed so that the sub flow via the network A 111 is used as a backup path and the sub flow via the network B 112 is used as a regular path. In the power saving state 502, a wait for an activation request from the communication partner apparatus 401 is performed, and a state query packet arrives at the communication processing apparatus 101 every fixed amount of time, but the amount of communication that is performed is very small in comparison to the normal power state. Accordingly, in the power saving state 502, it is possible to use the sub flow via the network B 112 as a regular path, and stop the supply of power to the cryptographic processing unit 103 which is used to guarantee the security of the sub flow via the network A 111.

Note that, if communication quality of the sub flow via the network B 112 for example has decreased, the communication partner apparatus 401 can send a query packet via the network A 111 which is the backup path. In this case, the power control unit 104 can supply power to the cryptographic processing unit 103. As a concrete example, the communication processing apparatus 101 may transition to a second power saving state where the cryptographic processing unit 103 to which power is supplied operates at a low operating frequency, or the communication processing apparatus 101 may return to the normal power state 501.

Here, with reference to FIG. 6, explanation is given for a state transition flow of the communication processing apparatus 101 for a case of transitioning from the normal power state 501 to the power saving state 502 and for a case of transitioning from the power saving state 502 to the normal power state 501.

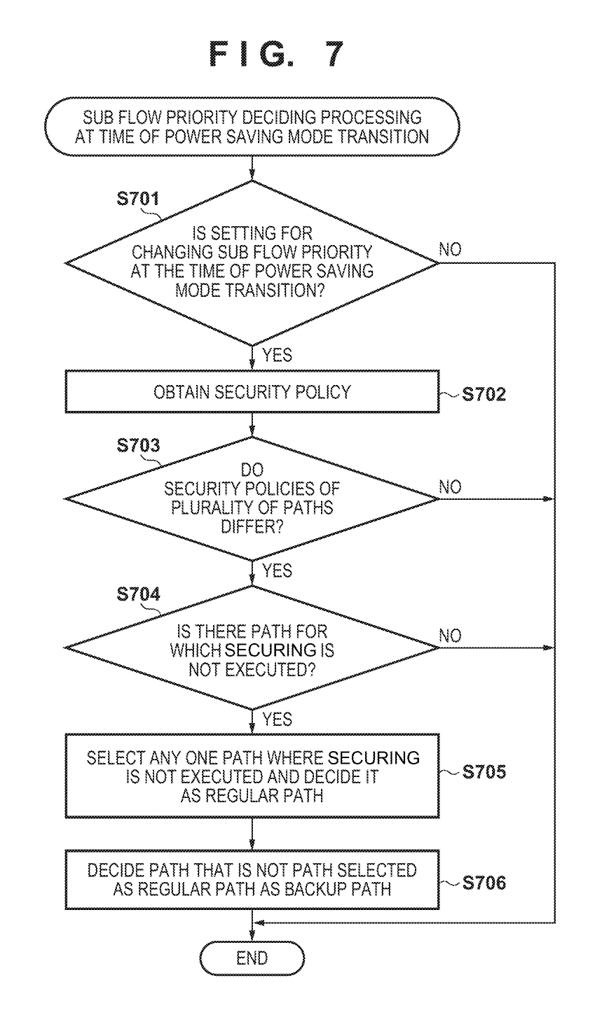

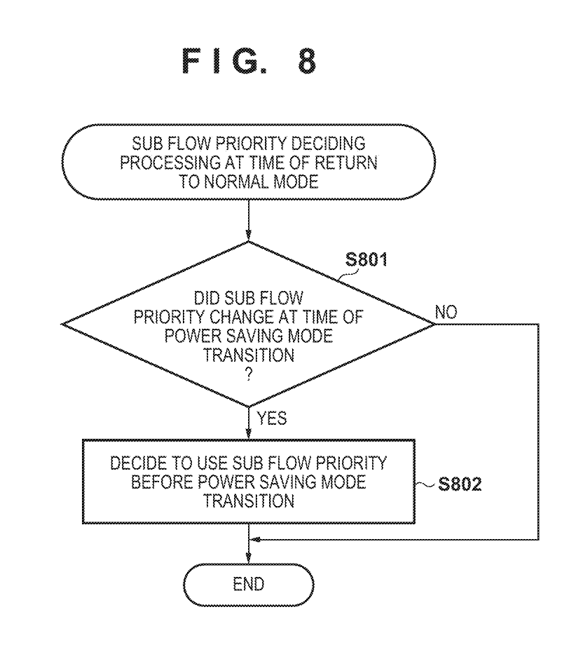

In step S601, the power control unit 104 waits until the power control unit 104 detects a power mode transition. The power control unit 104 receives a change instruction for an operation state of the communication processing apparatus 101. In the case of the present embodiment, the power control unit 104 receives a power mode transition instruction, in particular. In response to receiving this transition instruction, the power control unit 104 detects a power mode transition. When the power mode transition is detected, the processing proceeds to step S602. In step S602, the priority management unit 202 performs processing for deciding the priority of a sub flow. In step S602, processing illustrated in FIG. 7 is performed in a case of transitioning from the normal power state 501 to the power saving state 502. In addition, processing illustrated in FIG. 8 is performed in a case of transitioning from the power saving state 502 to the normal power state 501.

Here, with reference to FIG. 7, explanation is given regarding the processing of step S602 in the case of transitioning from the normal power state 501 to the power saving state 502. In the present embodiment, the priority management unit 202 refers to setting information that has been defined in advance, determines how to change the role of a path in accordance with the power mode transition instruction, and performs control for changing the role of the path in accordance with the determination. The setting information in the present embodiment includes information indicating a security policy set by the communication processing apparatus 101, and in particular security policies respectively used by a plurality of sub flows. The priority management unit 202 refers to the security policy to determine how to change the role of a path. Meanwhile, it is also possible to use setting information indicating an association relationship between a type of a power mode and the role of a path in this power mode. In this case, in step S602, the priority management unit 202 can decide the role of each path that corresponds to an instructed power mode without performing the processing of FIG. 7.

In step S701, the priority management unit 202, in a case of having detected a transition of a power saving state, determines whether a setting to change the priority of a sub flow is valid. Under setting not to change the priority, the processing of FIG. 7 ends. Under setting to change the priority, the processing proceeds to step S702. Configuration may be taken such that this setting can be set for each application, can be set in accordance with a user operating an interface, and can be set in accordance with control by the communication partner apparatus 401.

In step S702, the priority management unit 202 obtains a security policy set by the communication processing apparatus 101. In step S703, the priority management unit 202 confirms whether security policies used by a plurality of sub flows are respectively different. If they are not different, the processing of FIG. 7 ends. If they are different, the processing proceeds to step S704.

In step S704, the priority management unit 202 confirms whether there is a path for which the communication processing apparatus 101 is not performing a security guarantee. When there is no such path, the processing of FIG. 7 ends. When there is such a path, the processing proceeds to step S705. In addition, the priority management unit 202 may confirm whether there is a path for which a security guarantee is being performed independently of the cryptographic processing unit 103. For example, configuration may be taken such that the processing proceeds to step S705 if there is a path for which security can be guaranteed in accordance with processing by the main CPU 102 only.

In step S705, the priority management unit 202 selects the path for which the communication processing apparatus 101 is not performing a security guarantee or the path for which a security guarantee is being performed independently of the cryptographic processing unit 103, and decides this to be a regular path. For example, the priority management unit 202 may select one path for which security can be guaranteed by action of the main CPU 102 only, and decide this to be a regular path. In step S706, the priority management unit 202 decides paths other than the path selected as the regular path to be backup paths. In this way, by deciding the priority so as to preferentially use the sub flow passing through the network B 112 for which the local network 404 guarantees security, it is possible to increase a power saving effect when the power of the cryptographic processing unit 103 is disconnected at a time of a power saving state transition.

In this way, in the present embodiment, the priority management unit 202 changes the role of a path in accordance with an instruction for transitioning to a power mode having lower power consumption, for example an instruction for transitioning from the normal power state 501 to the power saving state 502. In the example of FIG. 4, the sub flow passing through the network A 111 is an established transport layer connection that passes through a path for which a securing process is performed by the communication processing apparatus 101. In addition, the sub flow passing through the network B 112 is an established transport layer connection that passes through a path for which a securing process is performed by an external apparatus. In this example, the priority management unit 202 can set the role of a path for which a securing process is performed by the communication processing apparatus 101 to a backup path, in accordance with an instruction for transitioning to a power mode that has lower power consumption. In addition, the priority management unit 202 can set the role of a path for which a securing process is performed by an external apparatus to a regular path.

In addition, in the present embodiment, the priority management unit 202 changes the role of a path in accordance with an instruction for reducing a supply of power to the cryptographic processing unit 103, for example an instruction for transitioning from the normal power state 501 to the power saving state 502. In the example of FIG. 4, the priority management unit 202 can set the role of a path for which a securing process is performed by the cryptographic processing unit 103 to a backup path, in accordance with this instruction. In addition, the priority management unit 202 can set the role of a path for which a securing process is not performed by the cryptographic processing unit 103 to a regular path.

In addition, with reference to FIG. 8, explanation is given regarding processing for a case of transitioning from the power saving state 502 to the normal power state 501. In step S801, the priority management unit 202, in a case of having transitioned to the power saving state 502, confirms whether the priority of a sub flow has changed. In a case where the change of a priority has not been performed, the processing of FIG. 8 ends. In the case where a change of a priority has been performed, the processing proceeds to step S802. In step S802, the priority management unit 202 decides the priority of a sub flow before transitioning to the power saving state to be the priority used when a transition has been made to the normal power state 501. In this way, the priority management unit 202 can change the role of a path via the network A 111 from a regular path to a backup path, for example, in accordance with an instruction for changing from the normal power state 501 to the power saving state 502. In addition, the priority management unit 202 can return the role of a path via the network A 111 from a backup path to a regular path, for example, in accordance with an instruction for changing from the power saving state 502 to the normal power state 501. In this way, in a case of transitioning from the power saving state 502 to the normal power state 501, the sub flow priority that was used in the normal power state 501 before the transition to the power saving state 502 is used.

In step S603, the priority management unit 202 compares the sub flow priority decided in step S602 with the present sub flow priority. If there is a change of the sub flow priority the processing proceeds to step S604, and if there is no change the processing proceeds to step S605. In step S604, the priority management unit 202 sends an MPTCP packet to which the MP_PRIO option is added to the sub flow for which the priority is to change. In this way, the priority of the sub flow is changed in accordance with the priority decided in step S602. Specifically, when the communication partner apparatus 401 receives this MPTCP packet, the communication partner apparatus 401 uses a sub flow having a high priority to send data to the communication processing apparatus 101.

In step S605, the power control unit 104 performs power mode transition processing, and this processing ends. For example, the power control unit can disconnect a supply of power to the cryptographic processing unit 103 together with transitioning from the normal power state 501 to the power saving state 502. In addition, the power control unit 104 can restart a supply of power to the cryptographic processing unit 103 together with transitioning from the power saving state 502 to the normal power state 501.

By virtue of the present embodiment, it is possible to dynamically change the priority of a sub flow independently of a communication channel status, in the communication processing apparatus 101. In the present embodiment, the priority of a sub flow is decided in accordance with a transition of the power mode, but the priority of a sub flow may be decided in accordance with another state change of the communication processing apparatus 101. In addition, in the present embodiment, a determination of whether it is OK to change a sub flow priority in accordance with a security policy setting is made, but a determination may be made by referring to other information as setting information. In contrast, configuration may be taken to set in the communication processing apparatus 101 whether it is OK for an administrator who decides a security policy or the communication partner apparatus 401 to change a sub flow priority in accordance with a transition of a power mode. By such a configuration, it is possible to decide a sub flow that is prioritized at the time of a power saving state transition without lowering a security level, and increase a power saving effect. In addition, as described above, because it is possible to control the priority of both uplink and downlink sub flows by using a communication processing apparatus according to the first embodiment as the communication partner apparatus 401, it is possible to more effectively improve a power saving effect.

In accordance with the present embodiment, even if the sub flow that passes through the network A 111 is changed to a backup path, communication that uses this sub flow is possible. Accordingly, even if a malfunction in the sub flow that passes through the network B 112 occurs at a time of a power saving state, it is possible to continue communication via the network A 111 instead. Accordingly, efficient operation while capitalizing on the merits of MPTCP is possible. Note that in a case of communication by a backup path, it is possible to temporarily supply power to hardware (the cryptographic processing unit 103) for which a power supply was turned off.

### Third Embodiment

In the second embodiment, description is given for a method of deciding the priority of a sub flow in accordance with a security setting of a communication processing apparatus, in response to a power mode transition. In the third embodiment, the priority of a sub flow is decided based on the power consumption of a communication interface that a communication processing apparatus has, in response to a power mode transition. The configuration of the communication processing apparatus 101 according to the present embodiment is similar to the configuration according to the second embodiment illustrated in FIG. 1 and FIG. 2. In addition, state transitions of the communication processing apparatus 101 are performed similarly to in FIG. 5, and power mode transition processing is also performed in accordance with FIG. 6. For the processing according to the present embodiment, the sub flow priority deciding processing in step S602 differs in comparison to that in the second embodiment. Explanation regarding points similar to those in the second embodiment is omitted below.

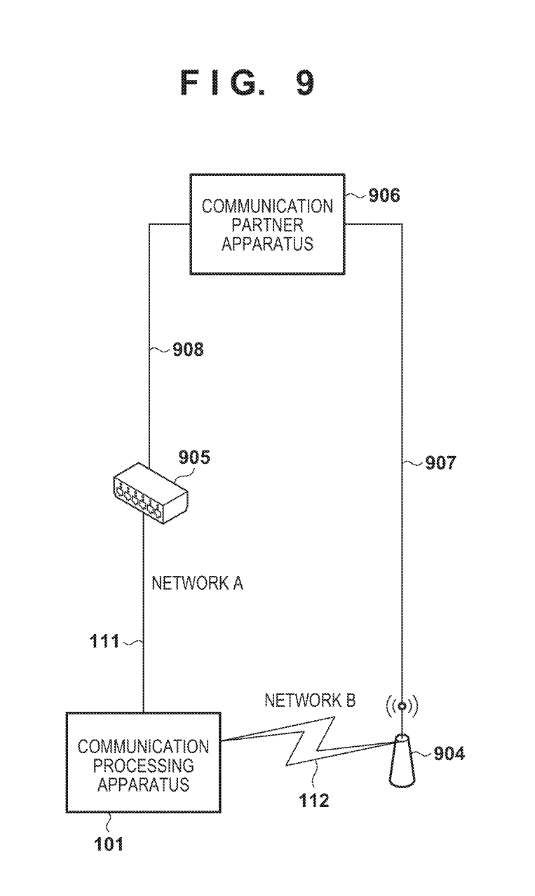

FIG. 9 illustrates an example of a network to which the communication processing apparatus 101 according to the third embodiment is connected. The communication processing apparatus 101 is connected to a communication partner apparatus 906 via the network A 111. The network A is a wired LAN connection by gigabit Ethernet (registered trademark), and can achieve communication throughput of 1 Gbps at a maximum. The network A 111 is connected to a switching hub 905 that relays communication. Furthermore, the switching hub 905 is connected to the communication partner apparatus 906 via gigabit Ethernet (registered trademark) 908. Note that, instead of the switching hub 905, the network A 111 may be connected to the communication partner apparatus 906 via a communication relay apparatus such as a bridge or a router.

In addition, the communication processing apparatus 101 is connected to the communication partner apparatus 906 via the network B 112. The network B is an 802.11ac Wave 2 wireless LAN network, and can achieve communication throughput that exceeds 1 Gbps by using a plurality of antennas. The communication processing apparatus 101 is connected to an access point 904 via such a wireless LAN. In addition, the access point 904 and the communication partner apparatus 906 are connected by 10 Gbit Ethernet (registered trademark).

In the present embodiment, in the normal power state 501, an MPTCP sub flow that reaches the communication partner apparatus 906 via the network B 112 is preferentially used as a regular path. In addition, a sub flow that reaches the communication partner apparatus 906 via the network A 111 is used as a backup path. In this way, in the normal power state 501, a network with a larger communication bandwidth is used preferentially. Note that, in the normal power state 501, the communication bandwidth may be enlarged by using the sub flow that reaches the communication partner apparatus 906 via the network A 111 as a regular path.

In the present embodiment it is possible to use two or more sub flows, and any number of sub flows may be used. In addition, specifications of the network A 111 and the network B 112 may be arbitrarily determined. For example, the communication processing apparatus 101 can have two types of network interfaces that differ to each other. In addition, the communication processing apparatus 101 may be provided with two wired LAN interfaces that support Energy Efficient Ethernet (EEE). In this case, although details are described below, it is also possible to switch the priority in accordance with whether a device that establishes a direct connection link with the communication processing apparatus 101 supports EEE.

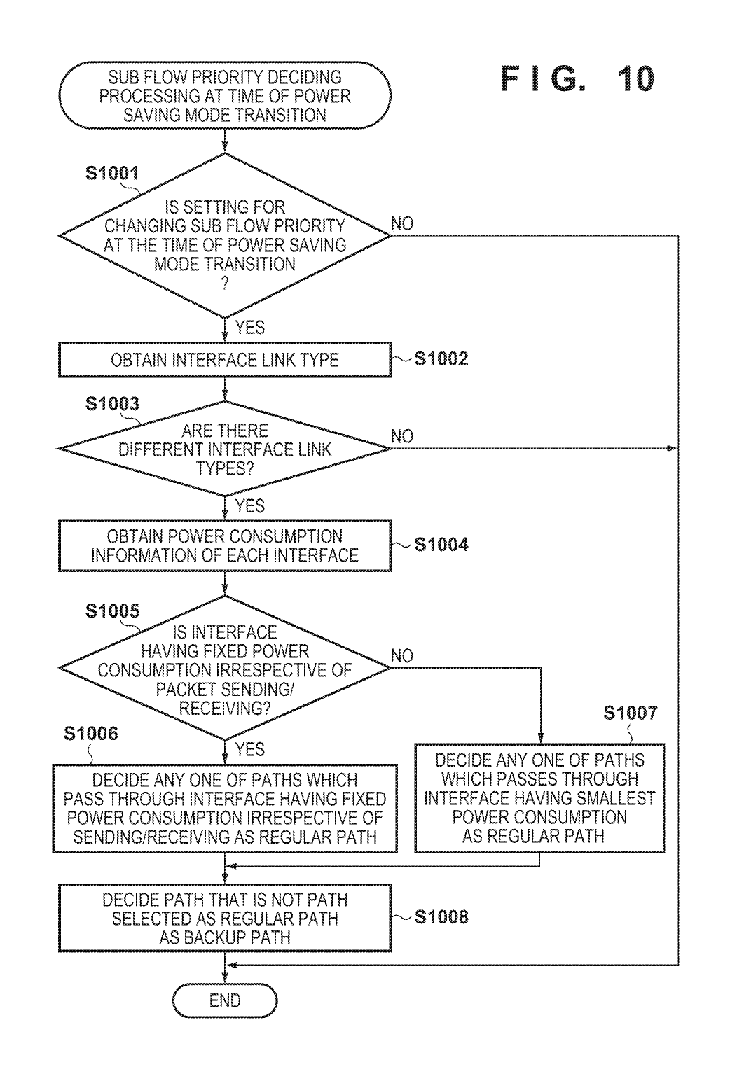

Next, with reference to FIG. 10, explanation is given regarding the sub flow priority deciding processing of step S602 in the present embodiment. The setting information in the present embodiment includes, for each respective path, information indicating an amount of power consumption at time of communication that passes through a path. In particular, the setting information includes information indicating an amount of power consumption by an interface that the communication processing apparatus 101 has at a time of communication that goes through the path. The priority management unit 202 refers to this amount of power consumption to determine how to change the role of a path.

Step S1001 is the same as step S701 of the second embodiment, and explanation thereof is omitted. In step S1002, the priority management unit 202 obtains the type of a link between a link destination and each interface that the communication processing apparatus 101 has. Link types include gigabit Ethernet (registered trademark), IEEE 802.11ac, a link with a device that supports EEE, a link with a device incompatible with EEE, and the like, for example.

In step S1003, the priority management unit 202 determines whether the respective interfaces have links of different types. If the link types are the same, the processing of FIG. 10 ends. In addition, when there are links of different types, the processing proceeds to step S1004. For example, in the case of FIG. 9, the types differ for the link via the network A 111 and the link via the network B 112.

In addition, even in a case where the communication processing apparatus 101 is respectively connected to a device that supports EEE and a device that does not support EEE, it is possible to determine that the links are of different types. Furthermore, even in a case where the communication processing apparatus 101 is respectively connected to a device that supports gigabit Ethernet (registered trademark) and a device that supports only 100Base-T such as Fast Ethernet (registered trademark), it is possible to determine that the links have different types. In these cases, the types of interfaces that the communication processing apparatus 101 has may be the same, but it is possible to determine that the types of links are different.

In step S1004, the priority management unit 202 obtains information of power consumed in a case where communication interfaces respectively communicate by using the present links. In step S1005, the priority management unit 202 determines whether there is the communication interface for which power consumption is fixed irrespective of whether packets are being sent and received. If such an interface link is present the processing proceeds to step S1006, and when not the processing proceeds to step S1007. For example, for a link in accordance with EEE and a wireless link, because the amount of power consumption of the interfaces temporarily increases at a time when sending and receiving occurs and the power consumption is reduced to less than or equal to a fixed amount when sending and receiving is not occurring, the power consumption is not fixed.

In step S1006, the priority management unit 202 decides a sub flow that passes through the communication interface for which power consumption is fixed irrespective of whether packets are being sent and received to be a regular path. Consequently, because an amount of communication using an interface for which power consumption increases at a time of communication decreases, it is possible to reduce power consumed in the power saving state. In step S1007, the priority management unit 202 decides a sub flow that passes through an interface having the lowest power consumption when sending and receiving to be a regular path. Because of this, it is possible to reduce power consumed at a time of operation in the power saving state. In step S1008, the priority management unit 202 decides sub flows other than the sub flow decided as a regular path to be backup paths.

In this way, in the present embodiment, the priority management unit 202 changes the role of a path in accordance with an instruction for transitioning to a power mode having lower power consumption, for example an instruction for transitioning from the normal power state 501 to the power saving state 502. In the example of FIG. 9, the communication processing apparatus 101, has the interface A 206 for performing communication via a path that goes through the network A 111, and the interface B 207 for performing communication via a path that goes through the network B 112. For the interface A 206, power consumption is fixed irrespective of the existence or absence of communication, and, for the interface B 207, power consumption becomes larger at a time of communication than at a time of no communication. In this example, the priority management unit 202 can set the path via the interface A 206 to a regular path in response to an instruction for transitioning to a power mode where power consumption is lower. In addition, the priority management unit 202 can set the path via the interface B 207 to a backup path.

As described above, in the present embodiment, it is possible to reduce total power consumption of the entirety of the communication processing apparatus 101 in the power saving state, by changing the priority of a sub flow based on the power consumption by an interface, in accordance with a power mode state transition. In contrast, it is also possible to dynamically change the priority of a sub flow independently of a communication channel status, in accordance with a state change by the communication processing apparatus 101 to something other than a power mode state. How to change the priority of a sub flow is not particularly limited, and is possible to use any method so that power consumption is reduced. For example, how to change the priority of a sub flow may be decided in accordance with control from an administrator or an external apparatus in consideration of power consumption by the entirety of a system and not only the power consumption by the communication processing apparatus 101 alone. As a concrete example, a method for changing the priority of a sub flow may be given such that the power consumption of the entirety of a system decreases when the entirety of the system transitions to a power saving state.

### Fourth Embodiment

As described above, how to change a priority is not particularly limited, and it is possible to use another method that does not depend on a communication channel status to dynamically change a sub flow priority. For example, it is possible to change the priority based on usage history information for a path. Usage history information for a path can be the usage status of a network or communication channel that passes through this path, or the usage status of this path, for data communication in a predetermined time period in the past. A communication traffic or a communication charge, for example, may be given as a usage status, and in an embodiment, it is possible to change the priority if the communication traffic or the communication charge has exceeded a threshold value. Such processing may be used in combination with the processing of the first to third embodiments.

As a concrete example, the priority management unit 202 can obtain usage history information for a path that passes through the network A 111. This usage history information may be a communication charge or communication traffic via the network A 111, for example, and can be obtained by monitoring these. The priority management unit 202 can refer to setting information that is defined in advance to determine how to change the priority of a path in accordance with usage history information, and perform control for changing the priority of the path in accordance with the determination. Here, the setting information may be a threshold value for a communication charge or communication traffic within a predetermined time period, and when the communication traffic or the communication charge has exceeded the threshold value, the priority management unit 202 can change the sub flow via the network A 111 from a regular path to a backup path. In addition, the priority management unit 202 can simultaneously change the sub flow via the network B 112 from a backup path to a regular path. Such a configuration can be used in a case where using the network B 112 reduces a communication charge more than using the network A 111 for example, and it is possible to reduce a possibility for a communication cost to greatly exceed a budget. Meanwhile, such a configuration can be used in a case where the network A 111 is a higher speed than the network B 112 for example, and it is possible to realize high speed communication within the scope of a budget. Such a configuration is merely an example, and the priority management unit 202 may change the priority based on a communication charge or communication traffic via the network B 112 for example.

In each embodiment described above, the priority of an MPTCP sub flow is made to be dynamically controllable in this manner. In addition to simply controlling a sub flow priority based on a communication channel quality or cost, it is possible to change the sub flow priority in accordance with the state of an information processing apparatus or a setting thereof, or control from an external apparatus. By using MPTCP an application can use a plurality of paths in a TCP connection without being aware of the presence of a plurality of communication paths. In such a case, efficient operation is possible to changing the priority in response to a status, in accordance with respective embodiments.

### OTHER EMBODIMENTS

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application Nos. 2017-033725, filed Feb. 24, 2017, and 2018-005948, filed on Jan. 17, 2018, which are hereby incorporated by reference herein in their entirety.

What is claimed is:

1. A communication apparatus, comprising:
a transceiver configured to communicate with another communication apparatus by establishing a TCP (Transmission Control Protocol) connection that includes a plurality of transport layer connections with different priorities and through different paths; and
a controller configured to change the priorities of the plurality of transport layer connections based on at least one of setting information of the communication apparatus or usage history information relating to the paths, after the TCP connection with the other communication apparatus is established by the transceiver.

2. The communication apparatus according to claim 1, wherein
a power mode of the communication apparatus is selected from a plurality of power modes with different power consumption, and
the controller is further configured to change the priorities of the plurality of transport layer connections based on at least one of the setting information or the usage history information, in response to transitioning to one of the plurality of power modes.

3. The communication apparatus according to claim 1, wherein the setting information includes information indicating a security policy for each of the paths.

4. The communication apparatus according to claim 1, further comprising a communication securing processor, wherein the controller is further configured to change the priorities of the plurality of transport layer connections so that a path which is secured by the communication securing processor becomes a backup path, when reducing a supply of power to the processing unit.

5. The communication apparatus according to claim 1, wherein
the transceiver is further configured to establish a transport layer connection through a first path which is secured by the communication apparatus, and a transport layer connection through a second path which is secured by an external apparatus, and
the controller is further configured to change the priorities of the plurality of transport layer connections so that the first path becomes a backup path, when the communication apparatus transitions from a first power mode to a second power mode with lower power consumption than the first power mode.

6. The communication apparatus according to claim 5, wherein the controller is further configured to change the priorities of the plurality of transport layer connections so that the second path becomes a backup path, when the communication apparatus transitions from the second power mode to the first power mode.

7. The communication apparatus according to claim 1, wherein the setting information includes, for each of the paths, information indicating an amount of power consumption in communication through the path.

8. The communication apparatus according to claim 1, wherein the transceiver comprises a first communication interface configured to perform communication via a first path, and a second communication interface configured to perform communication via a second path, wherein the first communication interface is a wired LAN interface incompatible with EEE (Energy Efficient Ethernet), and the second communication interface is a wireless LAN interface or a wired LAN interface that supports EEE, and
the controller is further configured to change the priorities of the plurality of transport layer connections when the communication apparatus transitions from a first power mode to a second power mode with lower power consumption than the first power mode.

9. The communication apparatus according to claim 1, wherein the controller is further configured to change the priorities of the plurality of transport layer connections in accordance with an instruction from at least one of a user, the other communication apparatus, or an external apparatus different from the other communication apparatus.

10. The communication apparatus according to claim 1, wherein the controller is further configured to change the priorities of the plurality of transport layer connections in data reception by sending a request for changing the priorities of the paths in data reception to the other communication apparatus.

11. The communication apparatus according to claim 1, wherein the transceiver if further configured to use Multi Path TCP to establish the TCP connection with the other communication apparatus.

12. The communication apparatus according to claim 1, wherein the priority is selected from a priority indicating a first path, and a priority indicating a backup path which is used when there is a problem in communication through the first path.

13. A communication method comprising:
establishing a TCP (Transmission Control Protocol) connection from a communication apparatus to another communication apparatus, wherein the TCP connection includes a plurality of transport layer connections with different priorities and through different paths; and
changing the priorities of the plurality of transport layer connections based on at least one of setting information of the communication apparatus or usage history information relating to the paths, after establishing the TCP connection.

14. A non-transitory computer-readable medium storing a program which, when executed by a processor of a communication apparatus, causes the communication apparatus to:
establish a TCP (Transmission Control Protocol) connection from the communication apparatus to another communication apparatus, wherein the TCP connection includes a plurality of transport layer connections with different priorities and through different paths; and
change the priorities of the plurality of transport layer connections based on at least one of setting information of the communication apparatus or usage history information relating to the paths, after establishing the TCP connection.
